(19) United States
(12) Patent Application Publication
(10) Pub. No.: US 2025/0220545 A1
(43) Pub. Date: Jul. 3, 2025

(54) NETWORK ASSISTANCE FOR SAMPLING RATE ADAPTATION

(71) Applicant: Nokia Technologies Oy, Espoo (FI)

(72) Inventors: Umur KARABULUT, Munich (DE); Ahmad AWADA, Munich (DE); Subhyal BIN IQBAL, Munich (DE)

(21) Appl. No.: 18/851,487

(22) PCT Filed: Mar. 31, 2022
(86) PCT No.: PCT/EP2022/058592

§ 371 Date: Sep. 26, 2024

(51) Int. Cl. H04W 36/36; H04W 36/00; H04W 52/02

(52) U.S. Cl. CPC H04W 36/362; H04W 36/0085; H04W 52/0235

(57) ABSTRACT

Method comprising: monitoring whether a terminal receives a function depending on one or more pieces of information used for preparing and/or performing a handover and/or a conditional handover from a source cell to a target cell; obtaining the one or more pieces of information; determining a value of the function based on the obtained one or more pieces of information if the function is received; setting a first sampling rate for measurements, by the terminal, of a reference signal of the source cell and for measurements, by the terminal, of the reference signal of the target cell based on the value of the function.

### FIELD OF THE INVENTION

The present disclosure relates to adaptation of the sampling rate of reference signal measurements. In particular, it is related to network assistance thereof.

### Abbreviations

3GPP 3rd Generation Partnership Project
5G/6G/7G 5th/6th/7th Generation
SSB Syncronization Signal Block
CHO Conditional Handover
CIO Cell Individual Offset
HO Handover
HOF Handover Failure
ID Identifier
MPUE Multi Panel User Equipment
MRO Mobility Robustness Optimization
NR New Radio
OAM Operation Administration and Maintenance
PP Ping Pong
RACH Random Access Channel
RLF Radio Link Failure
RSRQ Reference Signal Received Quality
RSRP Reference Signal Received Power
SSB Synchronization Signal Block
TE Too Early Handover
TL Too Late Handove
TTT Time To Trigger
UE User Equipment
WC Handover to wrong cell

### BACKGROUND

### MPUE Background

With the introduction of mmWave in 3GPP 5G NR, the need to compensate for the additional path loss at higher frequencies led to the proposal of antenna arrays at the base stations and User Equipment (UE). Patch arrays for mmWave at UE level are very directive with up to 30 dB front-to-back ratio and lead to having multiple array panels covering multiple spatial directions.

FIG. 1 shows schematically a multi-panel user equipment (MPUE) having three antenna panels. The antenna panels have directional patterns on different directions to cover the multiple spatial directions. For example, each of the antenna panels may have 5 dBi antenna gain in the respective forward direction and 25 dB backwards attenuation.

Depending on the UE hardware architecture, MPUEs can activate all panels simultaneously for simultaneous measurements of serving cell's reference signal and neighbor cell's reference signal (powers and or qualities). In some UEs, each panel can be activated independently from the other panels, and each panel may have a respective activation frequency, which may be different from the other ones or the same. The activation periodicity of each panel determines the sampling rate of each panel, i.e., how often a panel does sampling of cell measurements over time.

### Mobility (Handover) Background

In mobile networks, UE connects to the network through a cell which provides a good link quality, i.e., a link with signal-to-interference-noise-ratio above a certain threshold. If the UE moves away from the serving cell and gets closer to another neighbour cell (or target cell), the received signal power of the serving cell degrades and the interference from the target cell becomes dominant. Eventually, UE handovers to the target cell to sustain the connection to the network.

Received signal power (of a reference signal) of the serving cell is compared against that of target cell to determine whether it is necessary to handover the connection of a UE from serving cell to another. Those received signal power measurements fluctuate a lot due to channel impairments, e.g., fast-fading, measurement error, and shadow fading. Using those measurements without any filtering leads to wrong decisions due to rapid fluctuations and uncertainty on the measured signals. To mitigate those impairments and uncertainty (to prevent erroneous decisions) those raw measurements are filtered by a moving average filter (L1 filter, the result is also denoted “L1 measurements”) and a recursive filter (L3 filter, the result is also denoted “L3 measurements”) which provides a smooth measurement at the expense of a delay in the measurements (due to filtering).

UE measurements are a fundamental part of the mobility in mobile networks. UEs measure the quality of serving cell and neighbor cells where those measurements are used to decide handover of a UE from one cell to another. Inaccurate cell quality measurements lead to faulty handover decisions in the network and cause UEs to experience service interruption, e.g., Radio Link Failure (RLF), Handover Failure (HOF) or Ping-Pong (PP). Therefore, it is important for UE to achieve accurate cell quality measurements and, thus, good mobility performance.

During a handover procedure from the serving cell (source cell) to a target cell, L3 measurements (outputs of L3 filtering) from the serving and the target cell (a neighbor cell) are compared at UE. Herein, if L3 measurements of a neighbor cell c′ is offset o_{c0,c′}^{A3} dB better than the L3 measurement of the serving cell c₀ for time-to-trigger period T_{TTT} of time, UE sends measurement report to the serving cell. The time-to-trigger period is set by the network. Serving cell requests the handover from the target cell. If the target cell acknowledges the request, serving cell sends the handover command to the UE. UE initiates the handover with Random Access procedure on RACH right after receiving the handover command.

In detail, TTT is a timer value that is used together with the measurement report triggering condition. For example, if an A3 event is configured (i.e. a difference between the RSRPs (and/or RSRQs) of the source cell and the target cell is outside a certain range, e.g., RSRP of target cell becomes 3 dB stronger than RSRP of serving cell) and the TTT for this event is configured with a TTT value of 160 ms, UE evaluates the A3 condition. Once the A3 condition is satisfied, UE starts a TTT counter (a timer), and keeps monitoring the A3 condition. If the condition is not satisfied before the timer expires, i.e., RSRP of target cell becomes not 3 dB stronger than RSRP of serving cell but only 2 dB before TTT counter hits to 160 ms, UE resets the timer and does not trigger any measurement report and does not initiate handover procedure. It will only initiate the measurement report trigger or handover procedure, if the A3 event is satisfied for TTT seconds, e.g., RSRP of target cell remains 3 dB stronger than RSRP for serving cell for TTT seconds (e.g. 160 ms) (TTT counter hits to 160 ms without reset). This is the only moment where the UE initiates the RACH procedure. While TTT counter is running, UE is prohibited to initiate RACH towards target cell.

In MPUE case, the number of measurements per cell is scaled up with the number of panels on the UE and the UE has to determine which panel measurements to be used for assessing each cell quality or power measurement. As such, it may happen that the measurements of the serving cell and target cell are obtained from different panels, e.g., panel #1 is used for serving cell measurements and panel #2 is used for target cell measurements since panel #1 and #2 give the strongest measurements for serving cell and target cell, respectively.

### Mobility Robustness Optimization (MRO)

The conventional MRO (Rel9) assumes that the re-established cell after RLF is the candidate that UE should have performed handover to (assuming too late handover to re-established cell). This is further improved in Rel10, MRO with RLF report, where more information, measurements are added to RLF report to be used for root cause analysis. When an RLF happens, the UE stores some information (e.g., available measurements) into an RLF Report and indicates the availability of such a report to the network during the re-establishment process. The network can retrieve this RLF Report and use its content to analyze the mobility problems. Note that this allows also “offline” MRO purely based on the information in the RLF Report. This offline MRO does not necessarily have to be done right after re-establishment in the target/serving node, it can also be done in another entity collecting data over a longer time (e.g. trace collection entity).

### Sampling Rate Per Panel Differs Among UEs Due to, but not Limited to, the Following Reasons:

Hardware capabilities: UE with multi-panel architecture does not necessarily mean that multiple panels can be activated simultaneously for simultaneous measurements. In that case, UE has to schedule the activation of the panels over time.
   A straightforward approach is to use round robin scheduler where one panel is activated at a time, and one panel is activated after another panel is deactivated.
   An elaborate approach considers prioritization of the panels for certain mobility events, e.g., panels that are used in a most likely handover event (e.g., panel #1 and panel #2 from serving cell and target cell respectively, as explained in the previous section), will be prioritized and sampling rate of those panels are increased for accurate measurements whereas the panel #3 that is not needed in this most likely handover event is down-prioritized by reducing the sampling rate on that panel.
Power consumption: UE performs the cell quality measurements at the cost of power consumption. Even if UE is capable of simultaneous measurements on all panels, UE may operate under lower sampling rate per panel to reduce the power consumption on sampling. This is most likely the case if
   the UE implementation considers that accurate measurements are not needed,
   or UE is running out of battery.

Sampling rate of each panel and panel activation periodicity is UE's decision and it is implementation specific. In MPUE case, panel sampling rate has a significant impact on mobility performance since it will determine the accuracy of the measurements where UEs measure the signal power of serving cell and neighbor cells periodically to assess the quality of each cell to be used in handover decisions.

### SUMMARY

It is an object of the present invention to improve the prior art.

According to a first aspect of the invention, there is provided an apparatus comprising: one or more processors, and memory storing instructions that, when executed by the one or more processors, cause the apparatus to perform: determining a function based on radio signal change characteristics at a cell border between a source cell and a target cell; informing a terminal on the function, wherein the values of the function are sampling rates for measurements of a reference signal of the source cell and for measurements of the reference signal of the target cell or soft values corresponding to the sampling rates; and the function depends on one or more pieces of information used for preparing and/or performing a handover and/or a conditional handover from the source cell to the target cell.

According to a second aspect of the invention, there is provided an apparatus comprising: one or more processors, and memory storing instructions that, when executed by the one or more processors, cause the apparatus to perform: monitoring whether a terminal receives a function depending on one or more pieces of information used for preparing and/or performing a handover and/or a conditional handover from a source cell to a target cell; obtaining the one or more pieces of information; determining a value of the function based on the obtained one or more pieces of information if the function is received; setting a first sampling rate for measurements, by the terminal, of a reference signal of the source cell and for measurements, by the terminal, of the reference signal of the target cell based on the value of the function.

According to a third aspect of the invention there is provided a method comprising: determining a function based on radio signal change characteristics at a cell border between a source cell and a target cell; informing a terminal on the function, wherein the values of the function are sampling rates for measurements of a reference signal of the source cell and for measurements of the reference signal of the target cell or soft values corresponding to the sampling rates; and the function depends on one or more pieces of information used for preparing and/or performing a handover and/or a conditional handover from the source cell to the target cell.

According to a fourth aspect of the invention, there is provided a method comprising: monitoring whether a terminal receives a function depending on one or more pieces of information used for preparing and/or performing a handover and/or a conditional handover from a source cell to a target cell; obtaining the one or more pieces of information; determining a value of the function based on the obtained one or more pieces of information if the function is received; setting a first sampling rate for measurements, by the terminal, of a reference signal of the source cell and for measurements, by the terminal, of the reference signal of the target cell based on the value of the function.

Each of the methods of the third and fourth methods may be a method of network assistance for sampling rate adaptation.

According to a fifth aspect of the invention, there is provided a computer program product comprising a set of instructions which, when executed on an apparatus, is configured to cause the apparatus to carry out the method according to any of the third and fourth aspects. The computer program product may be embodied as a computer-readable medium or directly loadable into a computer.

According to some example embodiments of the invention, at least one of the following advantages may be achieved:
knowledge of the network may be used by the UE;
balancing of needed accuracy of the RSRP/RSRQ measurements for handover and power consumption;
particularly useful for MPUEs;
improved mobility behavior;
low signaling effort from network to UE and no additional signaling effort from UE to network;
UE may still decide on the sampling rate but gets a recommendation.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a MPUE with three antenna panels and their directional characteristics;

FIG. 2 shows recommendation functions using soft values for (a) rapid signal changes, and (b) slow signal changes;

FIG. 3 shows signaling diagrams for a handover for (a) the recommendation function of FIG. 2a and (b) the recommendation function of FIG. 2b;

FIG. 4 shows recommendation functions using hard values for (a) rapid signal changes, and (b) slow signal changes;

FIG. 5 shows signaling diagrams for a handover for (a) the recommendation function of FIG. 4a and (b) the recommendation function of FIG. 4b;

FIG. 6 shows an apparatus according to an example embodiment of the invention.

FIG. 7 shows a method according to an example embodiment of the invention;

FIG. 8 shows an apparatus according to an example embodiment of the invention;

FIG. 9 shows a method according to an example embodiment of the invention; and

FIG. 10 shows an apparatus according to an example embodiment of the invention.

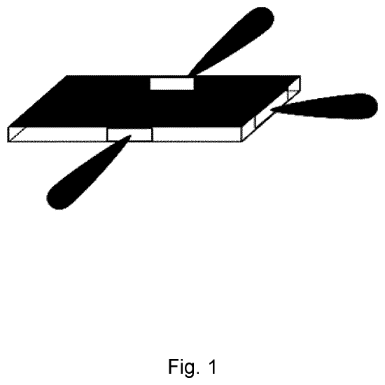

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Considering the different sampling rates of the reference signal by the UE (or the respective antenna panel of the UE in case of a MPUE), the following problems occur:
UE with a slow sampling rate acquires less number of samples (or statistics) which leads to inaccurate measurements. As mentioned hereinabove, those inaccurate measurements lead to erroneous mobility decisions.
On the other hand, power consumption of UE on measurement increases for increasing sampling rate which leads to drainage of UE battery over time.

As such, there is a trade-off between the measurement accuracy and power consumption when sampling rate per panel per cell is considered. On the other hand, the sampling rate is a UE decision and implementation specific where the network cannot increase the sampling rate for the sake of improved mobility performance.

In an exemplary mobility scenario (simulation scenario), a UE is moving along a direct path from close to the border between a serving cell (denoted cell 2) and another cell (denoted cell 19) towards another cell (denoted cell 6). The cells are arranged in a hexagonal lattice. L3 RSRP measurements were simulated for 60 ms and 20 ms sampling periods, respectively, where the former represents slow sampling rate and the latter represents fast sampling rate. For both simulations, every cell in the network transmits reference signal every 20 ms (SSB Signal with 20 ms period). At the beginning of each of the simulations, UE is served by cell 2 and both cell 2 and cell 6 measurement values are close to each other. The less frequent measurements every 60 ms lead UE to use non-updated measurements for L3 filtering and for evaluating handover conditions. After some simulation time (here: after about 6 s), the value of L3 RSRP measurement of cell 6 drops down and the L3 RSRP measurement of serving cell 2 increases to be larger than L3 RSRP measurement of cell 6. This is not observed by the UE with 20 ms sampling period due to stable samples. As a consequence, with a sampling period of 60 ms, UE handovers to cell 6 at simulation time of about 6 s and returns to cell 2 at simulation time of about 6.4 s. With a sampling period of 20 ms, UE does not perform any of these handovers. I.e., depending on the sampling period, UE could have stayed in the serving cell 2 to avoid unnecessary two consecutive handover, i.e. ping pong.

In mobile networks, each cell border has unique propagation characteristics (due to shadow fading impact) that also determines the mobility performance. A rapid signal change on a given path implies that handovers on this path are challenging. In this case, the handover should be initiated earlier so that the measurement report and handover command are transmitter and received before the link quality between source cell and the UE degrades too much. At other paths along cell borders, signal may fluctuate which may lead to unnecessary HOs, e.g., ping-pongs. In these cases, the UE should make sure that a handover is really necessary and does not result in PP.

MRO mechanism described hereinabove aims to optimize the mobility parameters for each cell border and alleviates aforementioned mobility problems. However, MPUEs with different sampling rate per panel will still experience different mobility performance (due to different measurement accuracy for different sampling rates) where the mobility problems due to slow sampling rates cannot be entirely mitigated with mobility parameter optimization. It is also not feasible for UEs to change the sampling rate per panel on the basis of cell border characteristics since the cell border characteristics are not known by the UEs (long term geographical observations needed which are not available to the UE).

As summary, MPUEs traversing the same cell border with rapid signal change experience different mobility performance, i.e., MPUEs with slow sampling rate experiences mobility problems due to mobility decisions based on inaccurate measurements. From another perspective, MPUEs with fast sampling rate traversing a cell border with slow signal change (area in which the UE can connect to either cell is wider) drains the UE battery unnecessarily, i.e., level of accuracy enabled by fast sampling rate (and high battery consumption) is not critical on cell borders with slow signal change. Despite the fact that each cell border characteristics require different sampling rate on MPUEs, the UEs do not know what kind of signal change rate the cell border has (fast or slow signal change). Hence, they cannot decide on which cell border to increase/decrease the sampling rate per panel accordingly.

In some example embodiments of the invention, the network assists MPUEs to enable different sampling rate for cell borders depending on the respective required measurement accuracies. As explained hereinabove, for example, the network can identify the cell border characteristics by MRO mechanism, i.e., applying root-cause analysis on certain mobility events and identify whether the cell border has slow/fast signal change characteristics. That is, the network may obtain its knowledge on the radio signal change characteristics at the cell border based on at least one of historical knowledge on the radio signal change characteristics and historical mobility events related to at least one of the source cell and the target cell. The network provides the UE with information to decide on increasing or decreasing the sampling rate per panel on each cell border. Thus, the network's knowledge on cell border characteristics is leveraged.

According to some example embodiments, the network defines a function Rₛ=ƒ(X) where Rₛ is sampling rate per panel per cell and X is a vector that is defined by the network. This function is configured by network and given to the MPUEs. MPUEs use the function to produce the sampling rate recommendation Rs and adapt their sampling rate per panel accordingly. The input vector, X, may comprise any information which is available to the UE. In particular, it may comprise information used by the UE in the preparing and performing a handover via the respective cell border. For example, the vector may comprise at least one of target cell ID, signal power e.g., Reference Signal Received Power or Quality (RSRP or RSRQ) values from serving cell and target cell, time to trigger (TTT) related parameter configurations and counter values, a speed of the UE (stationary, low speed, medium speed, high speed), and whether or not the target cell is prepared for CHO. Vector, X, may comprise one of the listed values, or any combination of those which would be determined by the network. For example, the speed of the UE may be used in preparing a CHO.

The function values may be soft values or hard values (real values). If the recommended sampling rate Rₛ is a soft value, Rₛ may takes discrete values (such as 1, 2 or 3), where 1 recommends slow sampling rate (less accurate measurements needed) when accurate measurements are not needed, e.g., UE is in cell centers, and 3 recommends high sampling rate when accurate measurements are needed, e.g., when the UE is on the cell border. When the Rₛ is low, UE reduces the sampling rate to save energy, and if the Rₛ value is high it will increase the sampling rate to increase the measurement accuracy. If the recommended sampling rate Rₛ takes hard values such as 1/0.05, 1/0.20, 1/0.40, 1/0.80, 1/0.160. 1/0.40 means 1/0.040=25 samples per second (40 ms sampling period) on the panel that is used for cell quality measurements of the given target cell. Either the sampling rate or the sampling period may be indicated.

In both option 1 and 2, UE can use the sampling rate recommendation function ƒ(X) to update the sampling rate per panel over time since the level of accuracy might also change over time. E.g., when UE approaches to some cell borders, higher sampling rate and accurate measurements might be needed. The indication of soft values has the advantage that the UE can take into account easily other considerations with respect to the sampling rate. The present recommendation gives an indication if higher or lower sampling rates are preferred in view of the cell border characteristics. On the other hand, the indication of hard values may alleviate the UE from calculating the actual sampling rate. If a UE does not support an recommended sampling rate, it may select the sampling rate closest to the recommended one.

Hereinafter, an example using soft values is described at greater detail. The network defines a function Rₛ=ƒ(X) that takes input vector X and produces soft sampling rate values Rₛ ∈ {1,2,3}. The input vector X may be defined as
1. The difference between signal strength e.g., RSRP (or e.g. signal quality RSRQ) measurement Pₛ of source cell and RSRP (or RSRQ) measurement of any target cell (or a specific target cell) Pₜ, ΔRSRP=Pₛ−Pₜ. When the UE moves away from source cell and gets closer to the target cell, Pₛ decreases and Pₜ increases. Hence, ΔRSRP decreases indicating that the UE is close to cell border. Here, the input vector X would be defined as a vector of received signal powers, i.e., [Pₛ, Pₜ₁, Pₜ₂,] and soft value is calculated by function ƒ(X) based on the ΔRSRP. When ΔRSRP becomes smaller as the UE gets closer to the cell border, recommendation function produces higher soft values, recommending UE to increase the sampling rate per panel on that cell border.
2. The difference between TTT of the handover condition defined for a target cell t and the TTT counter T_{count} that is counted during the handover condition being satisfied on that cell border, i.e., ΔT_{TTT}=T_{TTT,t}−T_{count}. For example, if the handover condition is not satisfied yet, T_{count} will be zero (when the UE is in the cell center) where ΔT_{TTT} is equal to its maximum value, i.e., ΔT_{TTT}=T_{TTT},t. When the UE gets closer to the cell border, handover condition will be satisfied and TTT counter, T_{count}, starts running on the target cell border. Eventually, ΔT_{TTT} starts decreasing. Here, the input vector X is defined as [T_{TTT,t}, T_{count}] and the soft value ΔT_{TTT} is calculated by sampling rate recommendation function ƒ(X) based on ΔT_{TTT}. When ΔT_{TTT} becomes smaller, recommendation function produces higher soft values, recommending UE to increase the sampling rate per panel on that cell border before declaring that the handover condition is satisfied for T_{TTT},t seconds (before sending the measurement report).
3. In conditional handover scenario, the input vector is a single binary entry where X=1 if the target cell is prepared for CHO, and X=0 if the target cell is not prepared for CHO. For input X=1, recommendation function may produce higher soft value. Similarly, for input X=0, recommendation function may produce smaller soft value.
4. The input vector may be simply the target cell ID (e.g. physical cell identity (PCI) or cell global identity (CGI)). Using the target cell ID, the UE determines the sampling rate soft value (out of many values provided by the network) corresponding to the target cell. In other words, the network will indicate to the UE the sampling rate value to be used with respect to a target cell or group of target cells.

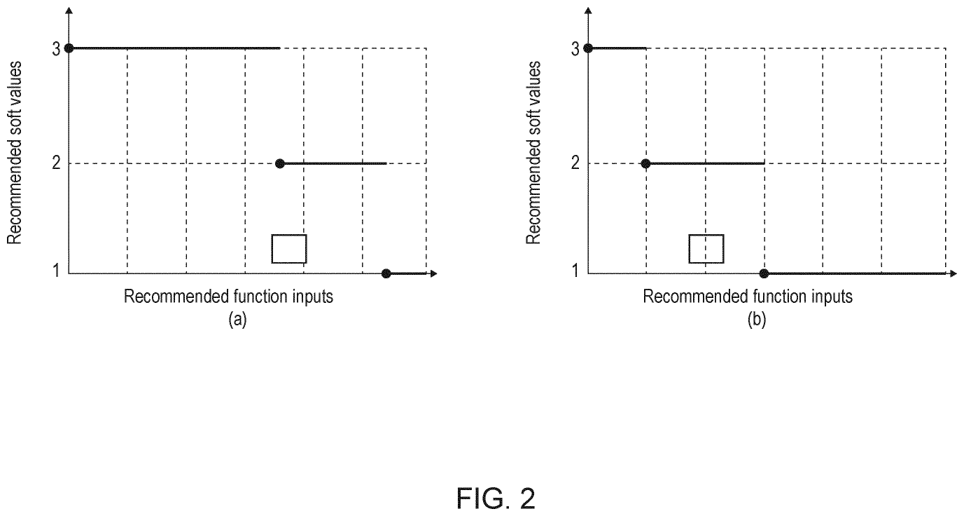

In FIG. 2, recommendation function examples are shown for two cell borders with different propagation characteristics. FIG. 2a represents a sampling rate recommendation function for a cell border with rapid signal change, and FIG. 2b represents a sampling rate recommendation function for a cell border with slow signal change. Recommended soft values (in y-axis) are given as function of input X (on x-axis) and input X can be either a vector with multiple elements or with a single entry, as described in the examples above. Note that the recommended soft values (in y-axis) in dependence on the input vector X are given by the network to the UE using broadcast or dedicated signaling. Assume that the x-axis is ΔRSRP in FIGS. 2a and 2b. When the ΔRSRP decreases (from right to left) the produced soft value increases rapidly from 1 to 3 in FIG. 2a since the cell border has a rapid signal change characteristics and requires UE to increase sampling rate per panel earlier. On the other hand, in FIG. 2b (cell border with slow signal change characteristics), decreasing ΔRSRP does not recommend fast sampling rate immediately, instead, it recommends UE to apply slow sampling rate until the power difference ΔRSRP becomes very small.

Nevertheless, in some example embodiments, the network may configure the same function for both cells. If the function of FIG. 2a is applied, the UE will start to apply the higher sampling rate when it approaches the cell edge irrespective if the cell border has a fast or slow change.

In summary, the proposed method enables UEs to be aware of the cell border propagation characteristics that is known on the network side. Hence, the UEs with multiple panel architecture can adapt the sampling rate per panel on each cell border accordingly.

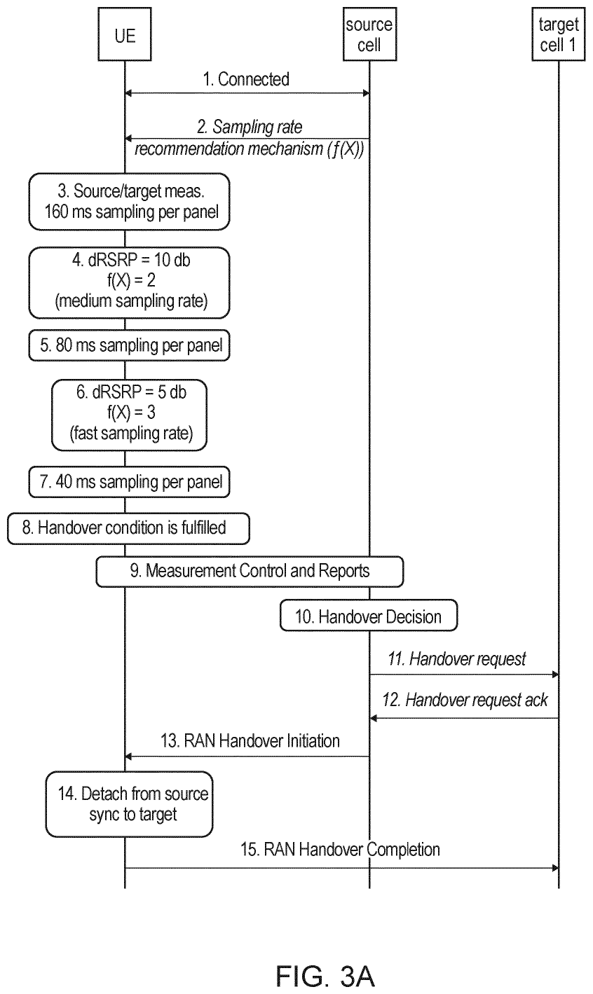

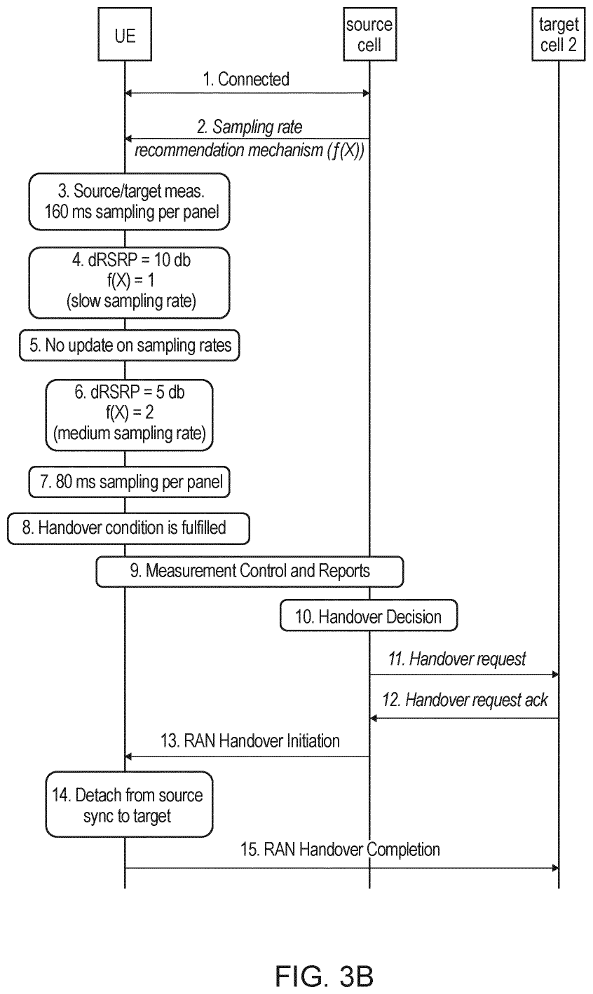

FIGS. 3a and 3b show signaling diagram of two handover scenarios using the recommendation function with soft values. FIGS. 3a and 3b represent the cell border characteristics and the recommendation functions that are defined by FIGS. 2a and 2b, respectively. Here, it is assumed that the input vector X of the recommendation function ƒ(X) is defined as X=[Pₛ, Pₜ] and ƒ(X) calculates the recommendation (soft value corresponding to panel sampling rate) based on ΔRSRP. The actions in both signaling diagrams are as follows:
1. UE is connected and served by the source cell.
2. Source cell determines the sampling rate recommendation function ƒ(X) to be used by the served UE and configures UE to use the ƒ(X), i.e., defines the input vector X=[Pₛ, Pₜ] and the method ƒ(X). ƒ(X) varies for different cell borders (i.e., target cell) which have different propagation characteristics (fast or slow signal change) where the network is capable of determining those characteristics (from mobility related KPIs such failures and ping-pongs) since the characteristics of each of these cell borders is known by the network.
   a. Target cell border 1 in FIG. 3a has fast signal change characteristics, hence ƒ(X) is configured as shown in FIG. 2a.
   b. Target cell border 2 in FIG. 2b has slow signal change characteristics, hence ƒ(X) is configured as shown in FIG. 2b.
3. In both cases (FIGS. 3a and 3b) UE initially starts with sampling rate of 1/160 per panel (160 ms sampling period per panel).
4. ƒ(X) calculates soft value by using the difference between RSRP measurements of source and target cell where ΔRSRP=Pₛ−Pₜ, ΔRSRP=10 dB.
   a. ƒ(X) recommends soft value 2 (medium sampling rate) for given ΔRSRP=10 on target cell 1 border (FIG. 3a)
   b. ƒ(X) recommends soft value 1 (low sampling rate) for given ΔRSRP=10 on target cell 2 border (FIG. 3b)

Although the ΔRSRP is same on both target cell 1 and target cell 2 borders, ƒ(X) produces different sampling rates since each cell border requires different sampling rate due to different propagation characteristics.
5. UE uses the acquired soft value on sampling rate per panel recommendation from action 4 and decides on whether to update the sampling rate per panel on respective cell border. Here, other considerations not related to the cell border characteristics may be additionally taken into account. In the present case, UE follows the recommendation of action 4.
   a. UE updates the sampling rate per panel on target cell 1 border from 1/0.160 to 1/0.80 (from 160 ms to 80 ms sampling period) since the soft value recommends medium sampling rate, i.e., ƒ(X)=2 (FIG. 3a).
   b. UE keeps the sampling rate per panel as 1/0.160 on target cell 2 border since the soft value recommends slow sampling rate, i.e., ƒ(X)=1 (FIG. 3b).

Hence, UE applies different sampling rates per panel on different cell borders with different propagation characteristics although the ΔRSRPs are same on both cell borders.
6. UE moves away from the center of the source cell and gets closer to cell border where the source cell power Pₛ decreases and target cell power Pₜ increases. Eventually, ΔRSRP decreases when the UE approaches to the cell border, i.e., ΔRSRP=5 (compared to action 4, it has decreased).
   a. Sampling rate recommendation function ƒ(X) recommends fast sampling rate, i.e., ƒ(X)=3, on target cell 1 border when ΔRSRP=5 (FIG. 3a),
   b. Sampling rate recommendation function ƒ(X) recommends medium sampling rate, i.e., ƒ(X)=2, on target cell 2 border when ΔRSRP=5 (FIG. 3b).
7. As described in action 5, UE would decide on the new sampling rate per panel for updated sampling rate recommendation function soft values (correspondingly to action 5)
   a. In target cell 1 border (FIG. 3a), UE increases the sampling rate per panel from 1/0.80 to 1/0.40 (40 ms sampling period) for increased sampling rate recommendation soft value (ƒ(X)=2→ƒ(X)=3)
   b. In target cell 2 border (FIG. 3b), UE increases the sampling rate per panel from 1/0.160 to 1/0.80 (80 ms sampling period) for increased sampling rate recommendation soft value (ƒ(X)=1=→ƒ(X)=2).

In the following actions, i.e., actions 8 to 15, the handover condition is satisfied and UE completes the handover from source cell to target cell successfully as described hereinabove, in both FIGS. 3a and 3b.

It is stressed that UE can apply different sampling rate per panel based on the recommendation function ƒ(X) that is configured by the network. Different propagation characteristics are known by the network. However, without defining such a function ƒ(X) to be used on UE side, the UE cannot decide on sampling rate per panel to adapt its sampling rate on cell borders with different propagation characteristics. So far, ƒ(X) for different cell borders are defined as shown in the examples of FIGS. 2a and 2b. The advantage of using ƒ(X) is explained on two scenarios in FIGS. 3a and 3b where UE can increase the sampling rate on the cell borders that require accurate measurements and reduce the sampling rate on the cell borders that has slow signal change characteristics to reduce the power consumption.

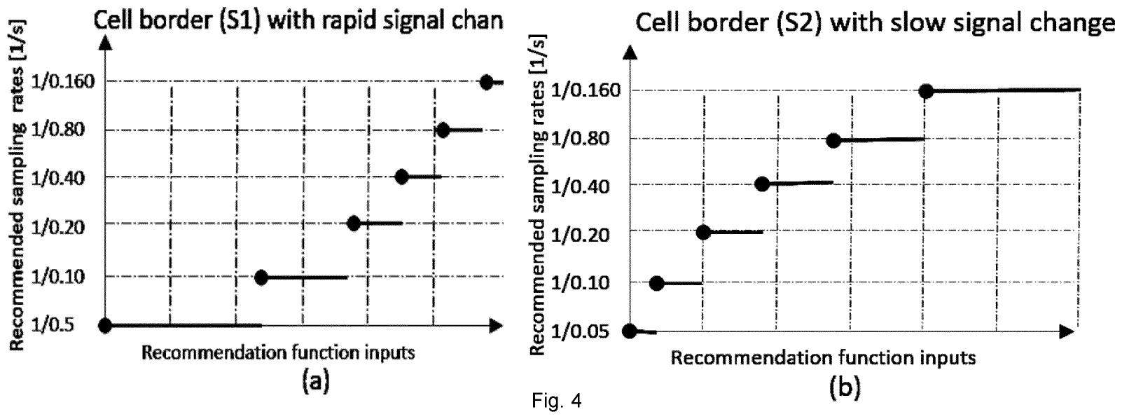

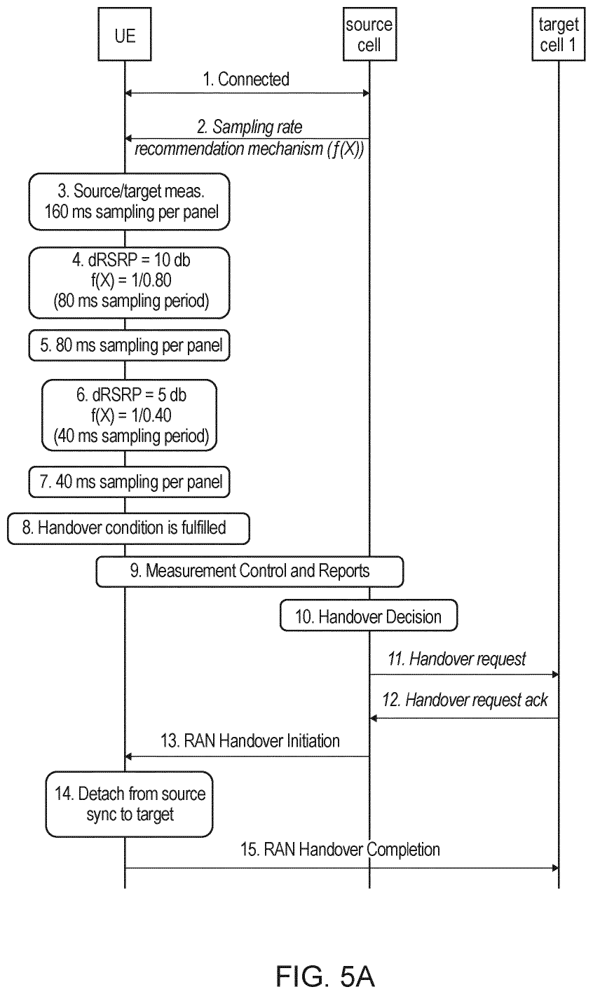

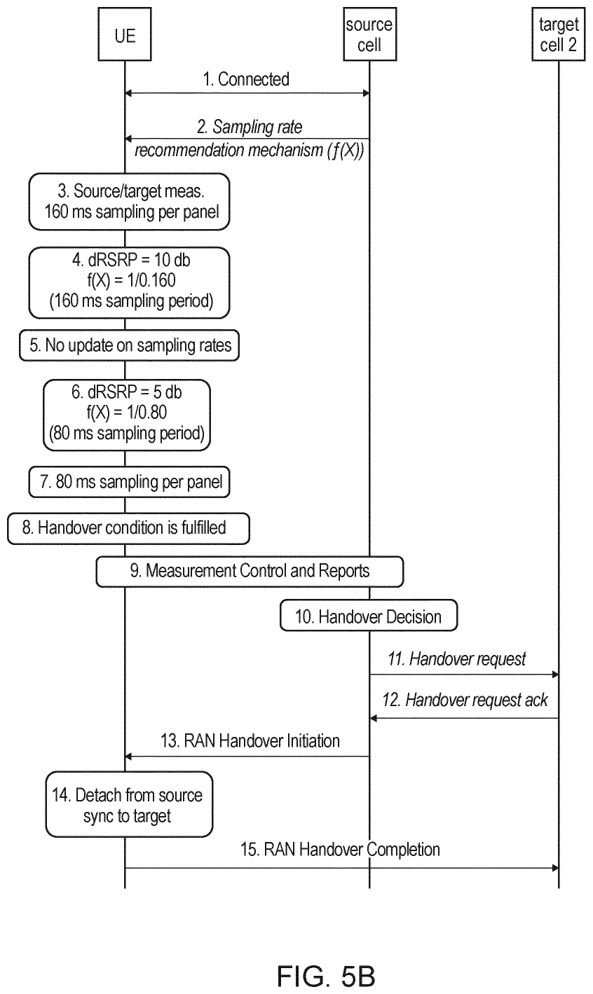

Another example, where the sampling rate recommendation function outputs take hard values, is explained with reference to FIGS. 4 and 5. In this case, the sampling rate recommendation function outputs the sampling rate (or the sampling period) to be used by the UE directly, i.e., ƒ(X)={1/0.05, 1/0.10, 1/0.20, 1/0.40, 1/0.80, 1/0.160} that correspond to sampling periods of 5, 10, 20, 40, 80 and 160 ms, respectively. Hence, the recommendation function would produce more granular or high resolution outputs for UE.

FIG. 4 shows two examples for sampling rate recommendation function ƒ(X) with hard value outputs. Recommendation function input vector X (x-axis) can be defined as it was described in option 1 and the hard values (y-axis) defined as {1/0.05, 1/0.10, 1/0.20, 1/0.40, 1/0.80, 1/0.160} which are also based on the SSB periods (denominators in seconds) that network can configure. Correspondingly to FIG. 2, FIG. 4a represents a recommendation function that is defined for a cell border with rapid signal changes, and FIG. 4b represents a recommendation function for a cell border with slow signal changes. As an example, if ƒ(X) calculates the ΔRSRP, the x-axis represents the ΔRSRP as it decreases from right to left on both FIGS. 4a and 4b. In FIG. 4a (cell border with fast change), the recommended sampling rate increases rapidly when the ΔRSRP decreases (even when the ΔRSRP is large, on the very right side of FIG. 4a). This is because the cell border requires early adaptation of per panel sampling rate. On the other hand, UEs on cell border that has slow signal change characteristics, would be configured to use the sampling rate recommendation function of FIG. 4b which recommends to improve the sampling rate slowly. It only offers high sampling rates if the ΔRSRP is really small, meaning that UE is very close to cell border.

FIGS. 5a and 5b illustrate the signalling diagram of a handover using the recommendation functions introduced by FIGS. 4a and 4b, respectively. The signalling shown in FIGS. 5a and 5b corresponds to that of FIGS. 3a and 3b, respectively. The only, but effective, difference here is that the UE receives more detailed recommendation from the recommendation function ƒ(X) and can apply more elaborate per panel sampling rate algorithm to either increase the measurement accuracy or to save battery and need not to calculate the sampling rate based on the soft value.

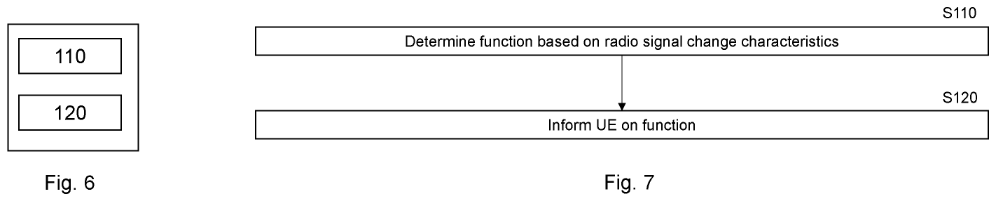

FIG. 6 shows an apparatus according to an example embodiment of the invention. The apparatus may be network (represented e.g. by a base station) or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for determining 110 and means for informing 120. The means for determining 110 and means for informing 120 may be a determining means and informing means, respectively. The means for determining 110 and means for informing 120 may be a determiner and informer, respectively. The means for determining 110 and means for informing 120 may be a determining processor and informing processor, respectively.

The means for determining 110 determines a function based on radio signal change characteristics at a cell border between a source cell and a target cell (S110). The values of the function are sampling rates for measurements of a reference signal of the source cell and for measurements of the reference signal of the target cell or soft values corresponding to the sampling rates. The function depends on one or more pieces of information used for preparing and/or performing a handover and/or a conditional handover from the source cell to the target cell.

The one or more pieces of information may comprise at least one of
results of one or more radio measurements to be performed by the terminal,
one or more parameter values provided to the terminal by at least one of the source cell and the target cell;
one or more derived values derivable by the terminal based on at least one of the one or more radio measurements and the one or more parameter values provided to the terminal.

The means for informing 120 informs a terminal on the function (S120). Typically, according to information known to the apparatus, the terminal is being served by the source cell.

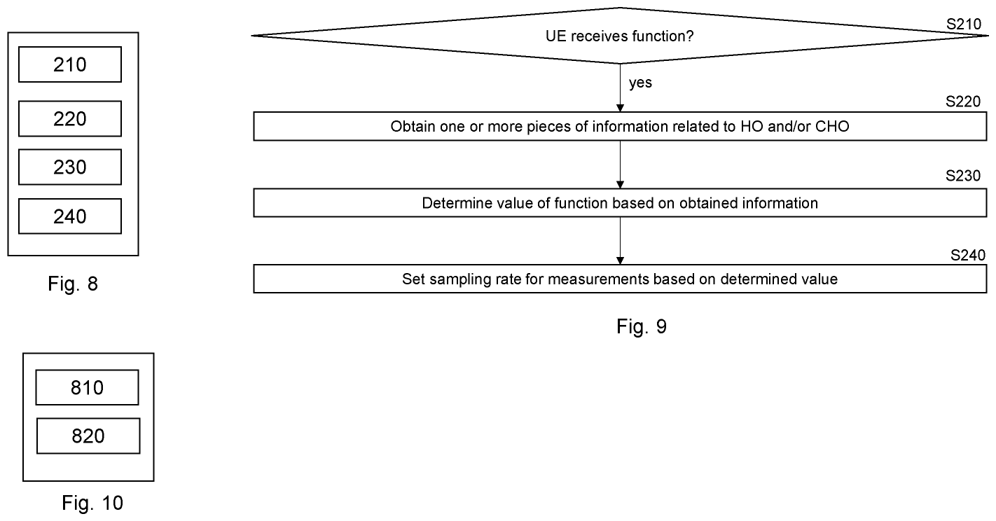

FIG. 8 shows an apparatus according to an example embodiment of the invention. The apparatus may be a terminal (such as a UE or a MTC device) or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for monitoring 210, means for obtaining 220, means for determining 230, and means for setting 240. The means for monitoring 210, means for obtaining 220, means for determining 230, and means for setting 240 may be a monitoring means, obtaining means, determining means, and setting means, respectively. The means for monitoring 210, means for obtaining 220, means for determining 230, and means for setting 240 may be a monitor, obtainer, determiner, and setter, respectively. The means for monitoring 210, means for obtaining 220, means for determining 230, and means for setting 240 may be a monitoring processor, obtaining processor, determining processor, and setting processor, respectively.

The means for monitoring 210 monitors whether a terminal receives a function (S210). The function depends on one or more pieces of information used for preparing and/or performing a handover and/or a conditional handover from a source cell to a target cell. For example, the one or more pieces of information may comprise at least one of.
results of one or more radio measurements to be performed by the terminal,
one or more parameter values provided to the terminal by at least one of the source cell and the target cell;
one or more derived values derived by the terminal based on at least one of the results of the one or more radio measurements and the one or more parameter values provided to the terminal.

The means for obtaining 220 obtains the one or more pieces of information (S220). For example, the means for obtaining may obtain the one or more pieces of information from one or more storage devices.

S210 and S220 may be performed in an arbitrary sequence. They may be performed fully or partly in parallel.

If the terminal receives the function (S210=yes), the means for determining 220 determines a value of the function based on the obtained one or more pieces of information (S230). The means for setting 240 sets a sampling rate for measurements of a reference signal of the source cell and for measurements of the reference signal of the target cell based on the value of the function (S240). The measurements are to be performed by the terminal.

FIG. 10 shows an apparatus according to an example embodiment of the invention. The apparatus comprises at least one processor 810, at least one memory 820 including computer program code, and the at least one processor 810, with the at least one memory 820 and the computer program code, being arranged to cause the apparatus to at least perform at least the method according to at least one of FIGS. 7 and 9 and related description.

Some example embodiments of the invention are described for a MPUE. However, some example embodiments may be applied to a UE with a single antenna (panel), too.

Some example embodiments are explained with respect to a 5G network. However, the invention is not limited to 5G. It may be used in other mobile communication networks, too, e.g. in previous of forthcoming generations of 3GPP networks such as 4G, 6G, or 7G, etc. It may be used in non-3GPP mobile communication networks, too, provided that the respective terminals perform measurements of reference signals.

A terminal may be e.g. a UE, a MTC device, a laptop, a smartphone, a mobile phone etc, suitable to operate in the respective network.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a terminal (such as a UE, a MTC device, etc.) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a network, e.g. represented by a base station such as a gNB or eNB or a cell thereof or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The phrase “at least one of A and B” comprises the options only A, only B, and both A and B. The terms “first X” and “second X” include the options that “first X” is the same as “second X” and that “first X” is different from “second X”, unless otherwise specified.

1-32. (canceled)

33. Apparatus comprising:
one or more processors, and
memory storing instructions that, when executed by the one or more processors, cause the apparatus to perform:
determine a function based on radio signal change characteristics at a cell border between a source cell and a target cell;
inform a terminal on the function, wherein
the values of the function are sampling rates for measurements of a reference signal of the source cell and for measurements of the reference signal of the target cell or soft values corresponding to the sampling rates; and wherein
the function depends on one or more pieces of information used for preparing and/or performing a handover and/or a conditional handover from the source cell to the target cell.

34. The apparatus according to claim 33, wherein the instructions, when executed by the one or more processors, further cause the apparatus to perform
obtain the radio signal change characteristics based on at least one of historical knowledge on the radio signal change characteristics and historical mobility events related to at least one of the source cell and the target cell.

35. The apparatus according to claim 33, wherein the one or more pieces of information comprise at least one of
results of one or more radio measurements to be performed by the terminal,
one or more parameter values provided to the terminal by at least one of the source cell and the target cell;
one or more derived values derivable by the terminal based on at least one of the results of the one or more radio measurements and the one or more parameter values provided to the terminal.

36. The apparatus according to claim 35, wherein at least one of:
the results of the one or more radio measurements comprise at least one of a signal power of the reference signal of the source cell, a signal power of the reference signal of the target cell, a signal quality of the reference signal of the source cell, and a signal quality of the reference signal of the target cell;
the one or more parameter values provided by at least one of the source cell and the target cell comprise at least one of an identifier of the source cell, an identifier of the target cell, a time to trigger a handover from the source cell to the target cell, and an indication whether or not the target cell is prepared for a conditional handover of the terminal to the target cell; and
the one or more derived values comprise at least one of a timer value indicating for how long a handover condition from the source cell to the target cell has been fulfilled, a difference between the timer value and the time to trigger, a difference between the signal power of the reference signal of the source cell and the signal power of the reference signal of the target cell, a difference between the signal quality of the reference signal of the source cell and the signal quality of the reference signal of the target cell, a speed of the terminal, and any logical and/or arithmetical combination of the one or more radio measurements and the one or more parameter values.

37. The apparatus according to claim 33, wherein the instructions, when executed by the one or more processors, cause the apparatus to perform the informing on the function by at least one of a dedicated signaling to the terminal and a broadcasting in the source cell.

38. The apparatus according to claim 33, wherein the one or more pieces of information are known to be available to the terminal without the terminal having to request any of the pieces of information from one of the source cell and the target cell only for determining the value of the function.

39. The apparatus according to claim 33, wherein the values of the function are sampling rates and/or wherein the values of the function are soft values for determining respective sampling rates.

40. The apparatus according to claim 33, wherein, according to information known to the apparatus, the terminal is being served by the source cell.

41. Apparatus comprising:
one or more processors, and
memory storing instructions that, when executed by the one or more processors, cause the apparatus to perform:
monitor whether a terminal receives a function depending on one or more pieces of information used for preparing and/or performing a handover and/or a conditional handover from a source cell to a target cell;
obtain the one or more pieces of information;
determine a value of the function based on the obtained one or more pieces of information if the function is received;
set a first sampling rate for measurements, by the terminal, of a reference signal of the source cell and for measurements, by the terminal, of the reference signal of the target cell based on the value of the function.

42. The apparatus according to claim 41, wherein the terminal comprises plural antenna panels having different directional characteristics; and the instructions, when executed by the one or more processors, further cause the apparatus to perform
identify a first one of the plural antenna panels on which the reference signal of the source cell has at least one of a maximum power and a maximum quality among the plural antenna panels;
identify a second one of the plural antenna panels on which the reference signal of the target cell has at least one of a maximum power and a maximum quality among the plural antenna panels;
set the first sampling rate for the measurements of the reference signals through the first one and the second one of the plural antenna panels;
set respective second sampling rates for the measurements of the reference signals through the other ones of the plural antenna panels, wherein the second sampling rates are not higher than the first sampling rate.

43. The apparatus according to claim 41, wherein the one or more pieces of information comprise at least one of
results of one or more radio measurements to be performed by the terminal,
one or more parameter values provided to the terminal by at least one of the source cell and the target cell;
one or more derived values derived by the terminal based on at least one of the results of the one or more radio measurements and the one or more parameter values provided to the terminal.

44. The apparatus according to claim 43, wherein at least one of:
the results of the one or more radio measurements comprise at least one of a signal power of the reference signal of the source cell, a signal power of the reference signal of the target cell, a signal quality of the reference signal of the source cell, and a signal quality of the reference signal of the target cell;
the one or more parameter values provided by at least one of the source cell and the target cell comprise at least one of an identifier of the source cell, an identifier of the target cell, a time to trigger a handover from the source cell to the target cell, and an indication whether or not the target cell is prepared for a conditional handover of the terminal to the target cell; and
the one or more derived values comprise at least one of a timer value indicating for how long a handover condition from the source cell to the target cell has been fulfilled, a difference between the timer value and the time to trigger, a difference between the signal power of the reference signal of the source cell and the signal power of the reference signal of the target cell, a difference between the signal quality of the reference signal of the source cell and the signal quality of the reference signal of the target cell, a speed of the terminal, and any logical and/or arithmetical combination of the one or more radio measurements and the one or more parameter values.

45. The apparatus according to any of claim 41, wherein the instructions, when executed by the one or more processors, cause the apparatus to perform the receiving the function by at least one of a dedicated signaling to the terminal and a broadcasting in the source cell.

46. The apparatus according to claim 41, wherein the one or more pieces of information are available to the terminal without the terminal having to request any of the pieces of information from one of the source cell and the target cell only for the determining the value of the function.

47. The apparatus according to claim 41, wherein the values of the function are sampling rates and/or wherein the values of the function are soft values for determining respective sampling rates.

48. Method comprising:
determining a function based on radio signal change characteristics at a cell border between a source cell and a target cell;
informing a terminal on the function, wherein
the values of the function are sampling rates for measurements of a reference signal of the source cell and for measurements of the reference signal of the target cell or soft values corresponding to the sampling rates; and
the function depends on one or more pieces of information used for preparing and/or performing a handover and/or a conditional handover from the source cell to the target cell.

49. The method according to claim 48, further comprising obtaining the radio signal change characteristics based on at least one of historical knowledge on the radio signal change characteristics and historical mobility events related to at least one of the source cell and the target cell.

50. The method according to claim 48, wherein the one or more pieces of information comprise at least one of
results of one or more radio measurements to be performed by the terminal,
one or more parameter values provided to the terminal by at least one of the source cell and the target cell;
one or more derived values derivable by the terminal based on at least one of the results of the one or more radio measurements and the one or more parameter values provided to the terminal.

51. The method according to claim 50, wherein at least one of:
the results of the one or more radio measurements comprise at least one of a signal power of the reference signal of the source cell, a signal power of the reference signal of the target cell, a signal quality of the reference signal of the source cell, and a signal quality of the reference signal of the target cell;
the one or more parameter values provided by at least one of the source cell and the target cell comprise at least one of an identifier of the source cell, an identifier of the target cell, a time to trigger a handover from the source cell to the target cell, and an indication whether or not the target cell is prepared for a conditional handover of the terminal to the target cell; and
the one or more derived values comprise at least one of a timer value indicating for how long a handover condition from the source cell to the target cell has been fulfilled, a difference between the timer value and the time to trigger, a difference between the signal power of the reference signal of the source cell and the signal power of the reference signal of the target cell, a difference between the signal quality of the reference signal of the source cell and the signal quality of the reference signal of the target cell, a speed of the terminal, and any logical and/or arithmetical combination of the one or more radio measurements and the one or more parameter values.

52. The method according to claim 48, wherein the informing on the function is performed by at least one of a dedicated signaling to the terminal and a broadcasting in the source cell.

53. The method according to claim 48, wherein the one or more pieces of information are known to be available to the terminal without the terminal having to request any of the pieces of information from one of the source cell and the target cell only for determining the value of the function.

54. The method according to claim 48, wherein the values of the function are sampling rates and/or wherein the values of the function are soft values for determining respective sampling rates.

55. The method according to claim 48, wherein, according to information known to an apparatus performing the method, the terminal is being served by the source cell.

56. Method comprising:
monitoring whether a terminal receives a function depending on one or more pieces of information used for preparing and/or performing a handover and/or a conditional handover from a source cell to a target cell;
obtaining the one or more pieces of information;
determining a value of the function based on the obtained one or more pieces of information if the function is received;
setting a first sampling rate for measurements, by the terminal, of a reference signal of the source cell and for measurements, by the terminal, of the reference signal of the target cell based on the value of the function.

57. The method according to claim 56, wherein the terminal comprises plural antenna panels having different directional characteristics; and the method further comprises
identifying a first one of the plural antenna panels on which the reference signal of the source cell has at least one of a maximum power and a maximum quality among the plural antenna panels;
identifying a second one of the plural antenna panels on which the reference signal of the target cell has at least one of a maximum power and a maximum quality among the plural antenna panels;
setting the first sampling rate for the measurements of the reference signals through the first one and the second one of the plural antenna panels;
setting respective second sampling rates for the measurements of the reference signals through the other ones of the plural antenna panels, wherein the second sampling rates are not higher than the first sampling rate.

58. The method according to claim 56, wherein the one or more pieces of information comprise at least one of
results of one or more radio measurements to be performed by the terminal,
one or more parameter values provided to the terminal by at least one of the source cell and the target cell;
one or more derived values derived by the terminal based on at least one of the results of the one or more radio measurements and the one or more parameter values provided to the terminal.

59. The method according to claim 58, wherein at least one of:
the results of the one or more radio measurements comprise at least one of a signal power of the reference signal of the source cell, a signal power of the reference signal of the target cell, a signal quality of the reference signal of the source cell, and a signal quality of the reference signal of the target cell;
the one or more parameter values provided by at least one of the source cell and the target cell comprise at least one of an identifier of the source cell, an identifier of the target cell, a time to trigger a handover from the source cell to the target cell, and an indication whether or not the target cell is prepared for a conditional handover of the terminal to the target cell; and
the one or more derived values comprise at least one of a timer value indicating for how long a handover condition from the source cell to the target cell has been fulfilled, a difference between the timer value and the time to trigger, a difference between the signal power of the reference signal of the source cell and the signal power of the reference signal of the target cell, a difference between the signal quality of the reference signal of the source cell and the signal quality of the reference signal of the target cell, a speed of the terminal, and any logical and/or arithmetical combination of the one or more radio measurements and the one or more parameter values.

60. The method according to claim 56, wherein the receiving the function is performed by at least one of a dedicated signaling to the terminal and a broadcasting in the source cell.

61. The method according to claim 56, wherein the one or more pieces of information are available to the terminal without the terminal having to request any of the pieces of information from one of the source cell and the target cell only for the determining the value of the function.

62. The method according to claim 56, wherein the values of the function are sampling rates and/or wherein the values of the function are soft values for determining respective sampling rates.

63. A computer program product comprising a set of instructions which, when executed on an apparatus, is configured to cause the apparatus to carry out the method according to claim 48.

64. The computer program product according to claim 63, embodied as a computer readable medium or directly loadable into a computer.
